(19) United States
(12) Patent Application Publication
(10) Pub. No.: US 2023/0214919 A1
(43) Pub. Date: Jul. 6, 2023

(54) AUTOMATED PROJECT DOCUMENTATION WORKFLOWS

(71) Applicant: Billd, LLC, Austin, TX (US)

(72) Inventor: Christopher Lee Doyle, Austin, TX (US)

(21) Appl. No.: 18/092,836

(22) Filed: Jan. 3, 2023

Related U.S. Application Data
(60) Provisional application No. 63/295,653, filed on Dec. 31, 2021.

(51) Int. Cl. G06Q 40/03

(52) U.S. Cl. CPC G06Q 40/03

(57) ABSTRACT

Systems and methods for automated project documentation workflows are provided. Where the project includes a lien, for example, related project documentation may be based on standing of a client and applicable legal deadlines in accordance with an agreement with the client and an assigned credit offer. An automated workflow may be generated based on such information, which may include various determinations regarding such factors as client standing, required actions, and related deadlines. The automated workflow may further be executed to generate one or more lien forms and related documentation, as well as to provide the prepared documents to identified recipient systems. The automated workflow may further include generation and transmission of a notification to a client device when the lien documentation is generated.

### CROSS-REFERENCE TO RELATED APPLICATIONS

The present patent application claims the priority benefit of U.S. provisional patent application No. 63/295,653 filed Dec. 31, 2021, the disclosure of which is incorporated by reference herein.

### BACKGROUND OF THE INVENTION

### 1. Field of the Disclosure

The present disclosure is generally related to a system and a method for project documentation, and more particularly related to a system and a method for automated project documentation workflows.

### 2. Description of the Related Art

Construction and similar projects may involve a variety of different types of parties each having associated with different sets of data, including contractors, sub-contractors, suppliers, property owners, lenders, etc. Such a project may generally entail the various parties providing information regarding one or more associated contracts, each of which may include information that needs to be verified, validated, and assessed. Moreover, each of the different parties involved may maintain different subsets of the data in different forms and formats, and as a result, project management has generally been a highly-specific manual process by which human managers manually search for, collect, analyze, and prepare different documents. Moreover, the documents may be subject to a variety of requirements, best practices, and policies associated with various governmental, regulatory, and financial bodies, and other entities. Thus, the manual processes for project documentation may be complex, time-consuming, and require trained personnel to perform properly.

In most commercial construction situations, contractors who specialize in a specific trade may work under a general contractor, who in turn works for the property owner. Contractors may purchase materials or other items from a supplier, who is paid by the contractor, which may pay the supplier by borrowing money from a lender. A conventional method of enhancing payment performance includes notifying a borrower of violation of payment obligation and warning of consequences if a payment obligation continues to fail. Further, the lender may report delinquencies to credit bureaus, thereby negatively impacting the borrower's credit score; or if secured, the lender can pursue foreclosure of the asset. However, these conventional methods are less than optimal, because these methods may not provide a security interest in case the lender remains unpaid and may also be time-consuming and prone to human error.

For example, a mechanic's lien is a legal claim against a property may be used by the lender in case the lender is not paid. The mechanic's lien provides lien rights to the lender against the property as a security interest in case the lender remains unpaid, which enables the lender to enforce a foreclosure action on the borrower's property and receive payment from the sale of the property. In the case of a government project, the lender can make a bond claim, which is a sum of money reserved to protect security against payment disputes on the project. Generally, the lien rights are available to the lenders who provide credit offers or materials for any construction project. These lenders possess the lien rights only by virtue of working on or contributing materials to a construction project. The mechanic's lien is a powerful tool to claim the paid debt. However, the right to file the mechanic lien may expire due to lack of preparation and failure to preserve such rights, since the mechanic's lien requires the lenders to take specific actions disclosed in state law to preserve their lien rights. For example, a lender that fails to take the right steps at the right time may lose their right to file a mechanic's lien entirely. Further, there exist a lot of other factors that can impact whether the lender has a right to file a lien or not. To maintain the lien rights, a preliminary notice is required to be sent to the borrower, and the deadline to send the preliminary notice may depend upon a state law. Consequently, a notice of intent is also required to be sent to the borrower within a pre-defined deadline. Since the process to preserve the lien rights is driven by very strict deadlines for specific actions (e.g., sending the notices within the time frames, meeting other factors or requirements), skipping any step during the process may lead to loss of lien rights.

As a result, such documentation—relating to specific actions and specific dates—may be quite time-consuming and labor-intensive. For example, parties currently must task human employees to monitor deadlines for recording the mechanic's liens in order to commence a legal action to enforce the mechanic's liens against the borrower. Further, time period to file the legal action to foreclose upon a mechanic's lien is generally very short, and such a short time period is frequently forgotten or overlooked, resulting in an unenforceable lien. In addition, the deadlines and statute of limitation deadlines may differ by jurisdiction (as well as subject to change), resulting in difficulty in determining the applicable deadlines and meeting applicable requirements by the applicable statute(s) of limitation. Presently available solutions lack the ability to identify, analyze, and resolve such conflicts that may arise in complex transactions subject to different requirements.

Thus, it can be seen that a need exists for an improved method and system for automated project documentation workflows.

### SUMMARY OF THE CLAIMED INVENTION

Embodiments of the present invention include systems and methods for automated project documentation workflows. Where the project includes a lien, for example, related project documentation may be based on standing of a client and applicable legal deadlines in accordance with an agreement with the client and an assigned credit offer. An automated workflow may be generated based on such information, which may include various determinations regarding such factors as client standing, required actions, and related deadlines. The automated workflow may further be executed to generate one or more lien forms and related documentation, as well as to provide the prepared documents to identified recipient systems. The automated workflow may further include generation and transmission of a notification to a client device when the lien documentation is generated.

### BRIEF DESCRIPTION OF THE DRAWINGS

FIG. 1 illustrates an exemplary network environment in which a system for automated project documentation workflows may be implemented.

FIG. 2 is a block diagram illustrating an exemplary automated project documentation workflow base module.

FIG. 3 is a flowchart illustrating an exemplary method for automated project documentation workflow.

FIG. 4 is a flowchart illustrating an exemplary method for credit limit adjustment.

FIG. 5 is a block diagram illustrating an exemplary lien module.

FIG. 6 is a flowchart illustrating an exemplary method for lien project documentation.

FIG. 7 is a flowchart illustrating an exemplary method for assessing applicable requirements for automated project documentation workflows.

FIG. 8 is a flowchart illustrating an exemplary method for implementing automated project documentation workflows.

### DETAILED DESCRIPTION

Embodiments of the present invention include systems and methods for automated project documentation workflows. Where the project includes a lien, for example, related project documentation may be based on standing of a client and applicable legal deadlines in accordance with an agreement with the client and an assigned credit offer. An automated workflow may be generated based on such information, which may include various determinations regarding such factors as client standing, required actions, and related deadlines. The automated workflow may further be executed to generate one or more lien forms and related documentation, as well as to provide the prepared documents to identified recipient systems. The automated workflow may further include generation and transmission of a notification to a client device when the lien documentation is generated.

In one instance, a computer-implemented method for filing a lien based on the standing of a client and legal deadline, the method includes analyzing an agreement with the client. The method further includes assigning a credit offer to the client based on the agreement made with the client. The method further includes performing a first determination if the client is not in good standing. In an exemplary embodiment, the system makes first determination that the client has not paid the amount to the lender and send a notice that lender can take an action of lien on the client. The method further includes performing a second determination if legal deadline for filing the lien is coming. For example, the system makes the second determination that the legal deadline for filing the lien is Nov. 20, 2021. The method further includes generating the lien form and sending the lien form to a third party for its filing. In an exemplary embodiment, the system generates the lien form sent a third party for filing the lien so that the lien can be filed before Nov. 20, 2021. The method further includes sending a notification to the client regarding the lien is generated. In an exemplary embodiment, the system generates the notification and sends it to the property owner to inform about the lien generated against his property.

General Contractor: A general contractor in commercial building development is a person, party, or organization which provides resources or services such as labor, material for completing a project, on a contract basis. The contract may be defined for a pre-defined scope and a certain price. Further, the contractor may be catering to multiple clients at the same time and may have a financial history and business history based previous contracts.

The contractor is responsible for the overall management of the project. The contractor may make use of bids for acquiring the project in the first place. Further, the contractor is accountable to any profit from the contract work. The contractor forms an agreement with the property owner. The contractor may also contract with subcontractors that are necessary to complete the project.

Contractor: A Contractor sub-contractor in a commercial building development is a person, party, or an organization which is hired by a general contractor of the commercial building development to perform a specific task associated with the building development. The Contractor is liable to the general contractor and is hired when a specific task requires certain set of skills or specialization. An example is a flooring company (contractor) may be hired by the general contractor to install a gymnasium floor for a new high school. The contractor purchases material, coordinates logistics with general contractor, submits material detail logs to general contractor for approval, provides labor to install the floor, quality checks the installation and provides a warranty to the general contractor for the performed work.

The contractor may be responsible for completing a specific portion of the contract, based on particular set of skills of the contractor. For a single project, multiple contractors can be hired by the general contractor for different tasks. The contractor forms an agreement with the general contractor and not with the property owner. The contractor may be in contact with a network of general contractors.

Contractor profile: A contractor profile represents professional achievement, with roles and responsibilities, of a specific contractor during the execution of different projects undertaken by the contractor over a period of time. The contractor profile includes data and documents referring to various activities associated with the project(s) and also contains general information such as contacts, telephone numbers, email addresses, etc. and specific information related to the contractor.

The contractor profile is mostly open to public access and ensures transparency. Any normal person can view or check the contractor profile via the internet and can decide to select or reject the specific contractor, based on their requirements. The contractor profile can provide various activities associated with the project(s) such as information regarding corporate values of the company, mission, experience based on the project, steps for client satisfaction, Labor resources, safety information, quality assurance program, design capability, Project Management and controls, Miscellaneous Maintenance, etc. undertaken by the contractor over a period of time.

Contractor revenue: Contractor revenue is the revenue generated against a contract undertaken by the contractor. The contractor revenue is also known as transaction price, which is defined as consideration, the contractor receives, in exchange for their services after the completion of a project on a reporting date.

The contractor revenue is dependent on multiple factors such as initial amount of revenue agreed for the execution of a contract or variations in the contract work, claims and incentive payments. The contractor revenue may increase or decrease by uncertainties such as cost inflation, penalties arising from delay etc. The uncertainties depend on the outcome of the future events. For example, the total contractor revenue included of revenues from the sale of recyclable materials less recyclables revenue payments or the total contractor revenue may also include of revenue received by the contractor for the sale of franchised materials or their resulting by-products.

Contractor expenses: Contractor expenses are the expenses incurred by a contractor during the interval between the execution and completion of a project. The contractor business expenses incorporate costs incurred during the daily course of the project. They can be applied to small projects and large projects. The Income statement is determined by the contractor expenses which is revenue to arrive at a contractor's taxable total income and subtraction of business expenses. The contractor expenses are directly proportional to the cost inflation during the project completion time, and it may increase than what it was during the previous year(s).

The contractor expenses are related to the trade of the contractors. The contractor business expenses incorporate the company emergence, accountancy fees, business travel expenses and accommodation, postage and stationery for business, training which directly related to the business to upgrade their skills, business phone calls, and equipment or machine purchased for business purposes. The Internal Revenue Code (IRC) mentions the guideline regarding business expenses in its section 162. It includes all the expenses which are common in the business industry and necessary for business purposes. Several contactor expenses are fully tax deductible such as advertising and marketing expenses, a few legal fees, utility expenses, etc. while some are partially tax deductible.

Contractor capital equipment: The contractor capital equipment is the items a contractor acquires but does not consume during the normal course of business or execution of a project. The items include assets that are primarily used for construction purpose such as machines, large vehicles, tools, computers, etc. Capital Equipment Policy is considered prior to make a purchase.

The companies obtain capital items to handle the business and to earn returns from the assets. A Construction project has the right set of equipment to get the job done. Getting the perfect equipment for each work helps with efficiency, safety, and build quality. Some equipment has many uses, while others are specific to a task. The capital equipment is assets, the expenditure required to put the assets in place, and ancillary costs such as taxes, installation charges, duty cost, freight, and insurance cost. The fixed asset category is subdivided into Capital equipment that includes industrial machinery and tools, office tools, large vehicles for transportation, furniture, and others. All these items are appropriately chargeable to the capital account.

Credit offer for contractor material: A credit offer for contractor material is a credit offer taken by the contractor for procuring the construction materials. Such type of credit offer enables a contractor to pay for the project materials not from their own funds. Also, contractors get cash to pay to the material suppliers before they can get paid by their customers. Thus, the contractor gets ordered materials long before they actually start work on a project.

Contractors mostly depend upon construction material credit offers to cover material expenses and protect their cash flow position. There are many ways that contractors can fund their material purchases through such credit offers such as trade credit, bank credit offers, supplier financing, and credit cards. Contractors open trade credit accounts with their material suppliers and avails the flexibility to delay payments for a certain period of time. To apply for bank credit offers, the contractors are required to provide audited financial statements that shows their business stability and success. Many contractors also use credit cards to purchase materials for their projects and pay the credit card company back according to the terms of the agreement which depends upon their credit score.

Credit offer—credit offer covered by materials: The credit offer is a type of credit offer covered by materials in the form of a credit card or credit offer to the contractor. The credit offer structure is covered for the material that depends on the project's cash flow for repayment, with the project's assets, rights, and interests. The Credit offer is also defined as offers provided by a ledger, such as banks, to the contractor for the material purchase.

Lenders may determine the type of credit offers, such as a cash back credit card or low interest credit card, based on the requirement. All such offers are governed by various acts such as the Fair Credit Reporting Act (FCRA). Contractors are provided with flexible credit offers based on their requirements. The terms offered for such credit offers depend on whether the credit offer from the lender is preapproved or prequalified. Preapproval is when a lender pre-screens a contractor and independently determines whether they meet their requirements for credit. If they meet the requirements for credit, then the lender sends a preapproved offer. Prequalification is when the contractor agrees to provide their credit information to a lender. Prequalification does not require a firm offer of credit.

Credit offer interest rate: The Credit offer interest rate is the rate at which a credit offer borrower is charged on the principal amount borrowed from a bank or a lender. Thus, the credit offer interest amount depends on the percentage of the principal amount borrowed from the bank or the lender. The annual interest rate applied on the sanctioned amount is termed as annual percentage rate (APR). The rate of interest is the effective rate for the borrower for credit offer and rate of return to the lender.

Some mortgages utilize simple interest, however, other utilize compound interest, which is applied to the principal and to the accumulated interest of prior periods. The credit score of an applicant is a primary factor to decide the interest rate by lending institutions. Other factors which impact credit offer interest rates are nature of employment or business, age, income etc. The income of the borrower determines their capacity to repay the credit offer. A borrower with a higher income has a better financial bandwidth to repay the credit offer on time. Also, the risk level for such type of borrower is low and lenders may prefer such borrowers with low-risk profiles and hence they offer you a lower interest rate.

Credit offer term:

The amount of time a lender gives to a borrower to repay the sanctioned credit offer is called the Credit offer term. It defines the repayment time period and various factors associated with the credit offer such as rate of interest, penalty fees (in case of delayed payment) depending upon this time period.

In return for a specified amount of money, the borrower accepts to a certain repayment plan with a fixed or floating interest rate. The credit offer is repaid by the borrower in regular payments over a set period of time. The period of time can be decided by the borrower which can last between one year to as long as 30 years in some cases. The borrower repays the credit offer amount with monthly or quarterly repayment principal and interest amount. The credit offer needed collateral and a rigorous approval procedure to minimize the risk of default or failure to receive the payments. Term credit offers normally carry no penalties if they are paid off prior of scheme time period. The credit offer team can be subdivided into short term credit offer, long term credit offer, and intermediate term credit offers. Example of Credit offer term, The Guaranteed credit offer which is also known as Small Business Administration (SBA) credit offer provides long-term financing. Short-term credit offers and revolving credit lines are also accessible to help with a company's instant and cyclical working capital requirements.

Contractor portal: A contractor portal is a virtual platform, used by a contract company or a person, to manage instructions and information that abide by organizational rules or customer requirements. The portal enables a user to register themselves based on different roles such as an administrator or customer. The users may access and navigate the portal based upon the login privileges assigned to them during registration.

The contractor portal can be used by various entities such as construction contractor, employer's contractors (HR firms) or any other entity which either hires or get hired on contractual basis. Such portals help the contractor to keep records of all the data related to their contract and make it accessible to all the stakeholders of the contract. The portal also provides the current information about the sources of supply and services to contract personnel.

Cloud: A cloud is a remote data storage system that logically stores the data. The data is stored in different physical storage servers, which are managed and owned by different entities. The owners of the cloud infrastructure are paid for the services they provide. The cloud can be accessed either through a collocated cloud computing service or by a web service application programming interface (API) or by applications that use the API which can be a cloud desktop storage, a cloud storage gateway or Web-based content management system.

A cloud can be used to store personal as well as public data. There is a default limit on the data storage depending upon whether the storage is for personal use or public use. The cost for securing the data stored in the cloud is always high because of the data being stored is in a distributed manner. The data is replicated and moved very often for security purpose so that no one can physically breach the data.

Computing device: A computing device is a multitasking device that consists of different elements. Such devices are capable of communicating with each other either directly or through a network. The computing device is used to carry out different functions such as a sequence of arithmetic or logical operations without human interference. Electronics devices take the input from the user, process the inputs, and calculates the output from the input. The mathematical devices which perform the calculations on the streams of binary format and equipment are controlled by the Central processing unit which has different software to perform different functions.

A computing device such as a PC, laptop, smartphone, or tablet is used by every individual and organization. The use of computing devices is vast, and its functionality fits in all the organizational work. The computing devices run on different operating Systems (OS) that makes them dominant in the surrounding. Several computing devices and peripherals perform data transfer by using infrared signals such as the signals used by a TV remote control device. Several laptops are equipped with IR transmitters and receivers for data transfer. Computers are used as a control system in several industries such as industrial robots and computer-aided designs. The computing devices have different configurations, models, designs, shapes, textures, weights, temperatures. The computing device has Internet connectivity and also have different software to perform connectivity between different devices to share information.

Network interface module: A network interface module (NIM) is an intermediate block that can be either hardware or software within an environment of a device. The module receives an incoming signal, such as RF (Radio Frequency) signal or HD (High Definition) signal and converts the received signal into a format that is understood by the device. Interface modules associate electronic devices with electrical systems at the control level. The module efficiently optimizes and manages the virtual network deployment. These modules are simply integrated into present architecture and hardware.

Routers and Ethernet LAN (Local Area Network) Switch are an example of network interface modules and are used for distributing consolidated virtual network traffic to a number of computing devices. Network Interface module can run on the central server based on the LAN/WAN (Wide Area Network) flexibility and availability. It controls a subset of main databases related to the site it controls. Several Network interface modules can connect and transfer data between multiple devices and the central server utilizing Ethernet and Transmission Control Protocol 9TCP)/Internet Protocol (IP) protocols.

Processor: A processor is an integrated digital circuit, used for performing and processing instructions of a user. The processor is responsible for carrying out all the input and output duties of devices such as computers, laptops, smartphones, etc. The functionality of the input and output devices is dependent on the performance of the processor. The processor executes a variety of functions on the data stored in the memory or the data input by a user or data retrieved from outside digital sources.

A processor is made up of four units namely Arithmetic Logic Unit (ALU), floating-point unit (FPU) registers, and cash memories. All the units' function together and give desired output depending upon the type of input/instruction(s). There are many different types of processors such as central processing unit (CPU), Graphics processing Units (GPU), etc. The primary functions performed by the processor are fetched, decode, execute and write back. The basic elements of a processor are the arithmetic logic unit, floating point unit, Registers, and L1 and L2 cache memory. The common types of processors are multicore in which integrated chips (IC's) consists of two or more processors for strengthening its performance, reduction in power consumption, and processing of multiple tasks simultaneously.

Display: A display is an output device, used to present information such as visual data including graphics, text, and numerals. The display includes a screen or a projection surface on which the information is produced. It provides man machine interaction in electronic devices such as computers, laptops, smartphones, Television set, Head-mounted displays, Heads-up displays, Virtual reality headsets, Broadcast reference monitor, medical monitors, Video Walls, etc.

Displays are also called Video Display Terminals or monitors. The input data of display is generally a character map or Bitmaps. Displays are made up of cathode ray tubes (CRT), light-emitting diodes, and Liquid crystal display. A display device usually consists of a visual display, several circuitries, a cover casing and a power supply. Some of the features of the display are ultra-wide screen, touch screen, Indicator light, and Power saving. The performance measurement of the display device is based on the display size, color characteristics, Aspect ratio, Resolution, Gamut and Input speed characteristics such as refresh rate, response time, and input latency.

Contract or agreement: A contract or agreement is a formal legal binding agreement that governs the rights and duties between or among the organizations or parties. The elements of a contract are offer, acceptance, intention to create legal relations, consideration, and legality of both form and content. When one of the parties in the binding agreement fails to deliver according to the terms of the agreement, the contract is breached, and the parties involved can resolve the problem among themselves or in the court.

A contract is enforceable by law when it meets requirements of the agreement, consideration, contractual capacity and law object. Contract limits the ability to bargain because of some legal restrictions. Contracts are of two types; one is called bilateral and other one is called unilateral. A bilateral contract is an agreement in which each party of the contract makes a set of promises to each other whereas the unilateral contract is an agreement in which one party makes a promise, but the second party does not promise anything to the other party.

Good standing: A person or an organization in good standing compiles with all explicit obligations, while not being subject to any form of sanction, suspension or disciplinary censure. Good standing of a company or an organization is proved by a legal document which is as per the laws of a specific state. The document proves that the company does not owe taxes and permit it to do business in a particular jurisdiction officially. A good standing can be used as a condition to help prevent fraud applications for necessary information or documents.

A good standing certificate proves that the entity or organization has paid all the fees and filed all the important reports. It is a type of certificate which is required by the organization to transact business in states other than their home state of registration. The certificate also has an expiration date which comes when the registration is due to be renewed or is due for a periodic maintenance fee.

Notification for payment: Notification for payment is a process to automatically keep track of purchase or transaction in real time. Payment notification can be messages of payment success or payment failure or current status of a payment. An automatic backend function keeps track of the information related to order tracking, customer payment and accordingly provides notifications related to the acquired services or transactions.

For example, an e-commerce software may record the information about the payment transactions through a payment gateway. Further, when the invoice is requested from the payment gateway, a payment notification message is sent to the E-commerce software from the payment gateway for successful or incomplete transactions. Further, the information on the contract payment notification includes details of the subcontractor, details of the contract and a declaration that the contract is not a contract of employment. Before a payment is made to the subcontractor, revenue of the gross amount of the intended payment is always notified.

Notification that lien may be filed: The notification that lien may be filed is also referred as the notice to intent to lien (NOI). The NOI gives warning to the property owner or other party that a bond claim may be filed unless the payment of the overdue amounts is made within a certain period of time. The notice of the intent to lien could be a replacement for a demand letter.

In state, federal and other public works projects, there is no requirement for NOI. It is often useful to send the Notice of Intent to encourage the parties so that they can make payment to avoid facing lien claim. A notice of intent to lien can be a replacement for demand letter and have the extra benefit of being relevant to parties other than the debtor. The notice of intent to lien document notifies the key project stakeholders about a payment problem, they may not foresee, and it also gives other stakeholders an opportunity to resolve the problem before a more adversarial lien claim is filed.

Notification of a property lien: Notification of a property lien is a legal claim on the assets where a creditor may seize the property and give notification to the debtor. The holder or the creditor gains access to the property if the debts are not paid. Since lien is a public record and is generally filed with a state agency.

A notification is attached to an individual property in case of any default by the debtor. In such a situation, the creditor can file a case against the debtor and receive approval for the property lien through government or state agencies. The property lien includes repossession of real estate property or equipment. It is the final step taken by a creditor against the debtor for collecting the unpaid debt.

List of building materials: List of building materials are the list of raw materials used during the construction of a building. Such list of materials is also known as construction material list. Cement, steel, sand, concrete, ready-mix concrete, binding wires, aggregates, bricks, blocks, etc. are few examples of building/construction materials. Building material have different properties such as weight, strength, durability, and cost which makes these materials suitable for various construction activities.

The building materials are selected precisely ensuring the protection and long life of the building. The materials and products are used by construction project managers or contractors for completing undertaken construction projects. Building materials are naturally occurring materials or may be manufactured products i.e., some are more synthetic, and some are fewer synthetic materials.

Lien History: A lien history is a history of legal rights against assets that are used as collateral to satisfy a debt. The lien history is established by a creditor or a legal judgement. It forms security interest that is granted over an item of property to secure the payment of a debt. Depending on the history behind the lien, the liens are referred as part of the process of purchase and may not be considered as a deal breaker.

Liens are of two types i.e., Personal liens or corporate liens. The difference between both the liens is that the corporate lien can become a type of investment whereas the personal lien cannot be considered as a part of investment. Further, liens can be consensual or non-consensual. Consensual liens between the creditor and the debtor are imposed by a contract whereas the Non-consensual liens are imposed by statute or by the law.

Underwriting process: Underwriting is a method through which an individual or institution takes financial risk, such as taking a credit offer in lieu of premium, insurance, or investments for a fee. Underwriting helps to place fair rates for borrowing in credit offers, establish appropriate premiums, and develop a market for securities by accurately pricing the investment risk.

The underwriting is a key function in financial world. An underwriter is an individual that sells the minimum number of securities of a company for commission. There are three types of underwriting i.e., credit offers, insurance and securities. A human underwriter is required for mortgage credit offer underwriting. The policyholder is the main focus in insurance underwriting. Securities underwriting assess risk and the appropriate price of securities such as IPO.

Project credit offer: A Project credit offer is a credit offer structure that depends on the project's cash flow for repayment and takes into account the project assets, rights, and interests. The project Credit offer is also defined as offers provided by a ledger, such as banks, to the contractor based on the project. Project credit offer is used to fund long term projects. They are usually non-recourse credit offers, which are protected by the project assets and repayment of the project is done by the complete cash flow of the project.

The offer includes the build, operation, and transfer (BOT) of the projects. Project credit offer provides off-balance-sheet financing of the project. The project risk is shifted to lenders in exchange for which the lenders obtain a higher margin for lending. Project financing offer is more complicated and alternative financing methods to attract borrowers for its project by offering special credit offers based on its project. These offers can change with respect to time by the financial institutions as per their credit policies.

Account credit offer: Account credit offer is defined as offers provided by a financial institution, such as banks, against a customer account. The account credit offers are sent to a user for rejection or acceptance by any suitable means such as a text message and/or via telephonic call.

These offers are customer and bank oriented for e.g., different banks provide different account credit offer to different customers depending on the transaction activities of the customers. The account credit offer depends on lenders to determine the type of credit offers, such as a cashback credit card or low-interest credit card, based on the account activity and requirement of the user. All such offers are governed by various acts such as the Fair Credit Reporting Act (FCRA). These offers are subject to change with respect to time on the basis of the transactions done by the customer against their account. These offers are defined as per the financial institutions and on its policies towards customer accounts.

Account credit: The account credits are an accounting activity in which money is credited to the account. All accounts that contain a credit balance may increase in amount when credit is added to them and reduced when a debit is added. The category of accounts to which this rule covers are liabilities, revenues, and equity. The credit may also be in the form of rewards.

For example, the rewards or cashback received by a user of GPay, Paytm, Paypal or Phonepay is a type of account credit because cashback is reflected in the customer's account. The cashback can be used as a normal currency for purchasing any kind of goods and services. The account credit can also be in form of contract agreement between the borrower and the ledger in which the borrower receives credit in the form of money from the ledger and repays at a later day with interest. The individual or company that provides credit is termed as the creditor. Credit is provided in exchange for a product or service given by the creditor to the account holder.

Account credit limit: The account credit limit is defined as an upper limit of credit associated with an account as extended by a creditor. The account holder, or customer, is free to withdraw any amount up to and including credit limit from the concerned account. The credit limit, linked to a customer, is based on customer's credit score, and may also impact their ability to get the credits in the future.

A customer applies for a credit in form of either a credit card and/or credit offer. The lender, which may be any financial institution, evaluates risks associated with the customer based on multiple factors such as spending habits and credit score. Based on these factors, the lender set an upper limit on the credit that the customer may utilize without any adverse effect. If the borrower spends more than the credit limit, then the borrower is fined and is required to pay the penalty in addition to their regular payments.

Real estate owner: A real estate owner is defined as a legal entity whose ownership of any real estate or property is recognized by the law of the land. A legal entity can be either individuals and/or organizations. A real estate owner has the ultimate control and right to use the property as long as the law permits. A real estate owner can be categorized in different types i.e., Individual Ownership or solo ownership, Joint or Co-ownership, and property ownership by nomination.

Any constructor or a potential buyer contacts the real state owner with a contract or lease proposal to accrue the real state property. It is up to the owner to accept or reject the proposal. Further, it is the responsibility of real estate owner to pay taxes on all the real estate they own. A real estate owner always has the ultimate responsibility for the maintenance and repair of the property. A real estate owner can transfer the property without any limitations. One can become owner of real estate by acquiring legally from previous owner, either in exchange for money, or as gift or donation.

Payment credit offer schedule: The payment credit offer schedule is defined as the schedule according to which a credit offer must be repaid by the borrower. A credit offer is repaid in multiple instalments, each paid at a fixed interval of time. The schedule of fixed time intervals on which the instalments are paid is called as payment credit offer schedule.

Generally, the installments are paid monthly and are commonly known as EMI. However, based on agreement of between lender and borrower, the instalments can also be paid quarterly, half yearly or annually. Instalments paid monthly are called EMI or equated monthly instalments. Instalments can be paid with fixed or variable rate of interest amount. Further it depends on the schedule of instalments. The payment credit offer schedule is important to the borrower to understand the credit offer repayment by breaking down the balance into equal monthly EMIs and also help borrower to calculate the total interest payable on the credit offer. The repayment schedule of the credit offer amount is the full list of that borrower is required to pay toward interest and principal over the period of the credit offer. The payment credit offer schedule is calculated based upon type of interest that is fixed rate of interest and variable rate of interest. During fixed rate of interest payment schedule remains fixed while during variable interest rate amount of payment of credit offer changes which also impact repayment schedule of the credit offer.

Credit limit: The credit limit is defined as a maximum amount of credit that can be used by a customer extended to them by a financial institution such as bank. The credit limit for a specific customer is based on customer's credit score and may also impact their ability to get credits in the future. Through the good credit score, it may affect the ability to get financing things like a car or start a business. The credit limit can also depend on the customer income.

For example, based on the customer credit score, one user may have one credit limit while the other user may have a different credit limit. The credit limit can be adjusted by the credit card issuer, if the customers are using the card wisely, for example, if the customer consistently made payments on time, the bank may increase the credit limit on customer current card because customers are considered less risky of a borrower to credit offer more money.

Insurance companies that insure against building material credit offers: The insurance companies that insure against building material credit offers are the companies which offer an insurance policy for the credit offers taken by the contractors to complete undertaken project. Sometimes, to procure building materials for construction of the building, the builder may need a credit offer. An insurance policy for building materials covers potential losses of builder during the construction phase of the building.

The building material credit offer helps contractors get money/finances to pay for their materials using cash received from bank. The insurance company that ensures building material credit offer check the signed document paper of contractor or builder and the documents include the budgets assigned to each portion of the project, building materials to be use and plans approved by the municipality. Further, if any chance the building materials gets damaged by fire, lightning, explosion, earthquake, and storm damage the risk Insurance Cover all.

Lien: Lien is defined as a legal right to keep possession of the property or real estate belonging to someone else until they have repaid all the debts. The lien is created by a creditor or legal entity and is mostly used to recover debt. When a borrower does not pay his mortgage or neglects to pay income or property taxes, a lien may be placed against his property as a way for the lender or the Internal Revenue Service to try and recoup what is owed to them.

The lien guarantees an underlying obligation such as repayment of credit offer. In case of failure of payment of the credit offer, the creditor or legal entity may seize the asset that is the subject of the credit offer. The lien may arise by the agreement of the parties, by the general usage of trade and by particular usage of trade. A lien can only be released by the organization or person who created it. However, some actions can take may release the lien including like, paying off the lien, settling the lien, correcting the lien, disputing the lien.

Liens—state laws: Liens state laws refer to different laws or guidelines set by different states concerning lien. Depending on the state, timelines for lien may change and therefore location of property should be kept in mind when initiating lien process. Different state liens laws have different timelines. In some states the lien of a properly docketed judgment affects all the debtor's property in every county where notice of the judgment is filed.

Where the contractor wants to work in a particular jurisdiction, they need to take measures of all the requirements by the Liens—state laws. The contractor should be aware of all the liens laws in that particular jurisdiction. A notification of a particular contractor working on a site should also be provided by the contractor to the government. The timelines of state lines laws can affect when you need to let the owner know you're working on a project.

Liens—federal laws: Liens federal laws are laws and guidelines regarding lien defined by the federal government. The federal law always controls federal lien property cases. A federal lien is the government's legal claim against your property when you neglect or fail to pay a tax debt. The government points out that a matter of federal law as to whether a lien created by a state statute is sufficiently specific. A federal tax lien records subsequent to an attachment lien, but prior to the date, the attaching creditor obtained judgment.

The federal law requires certified copy of the abstract of judgement and automatically creates lien on property or land in the state within district where court is situated. The federal court created judgement lien lasts for 20 years. Also, most of the states follows the 20 year 20-year rule but not some may not. The uniform Federal lien registration act provides for the registration of federal lien by procedures consistent with normal recording of mortgages in local area property records with the normal filing of security interest of personal property.

Specific actions to preserve their lien rights module: Lien is defined as a legal right to keep possession of the property or real estate belonging to someone else until they have repaid all the debts. The action to preserve the lien is to register the lien in the land registry office with the cost of land which the owner is claiming to be owed. Lien rights just by virtue of working on or contributing materials to a construction project, the right to lien may expire without the correct steps to preserve it.

Few steps such as sending notice, filing liens within a given time frame are to be fulfilled in order to preserve lien rights. Generally, direct contractors, subcontractors, material suppliers, equipment lessors, design professionals (architects and engineers), and laborer all have lien rights. A lien is a legal claim on the property title, which is very difficult to get rid of without paying the debt right. The lien rights help reduce financial risk for contractors, subs, and suppliers, all of whom are required to put up significant sums of their own money in advance.

Public or private rights module: The public right module deal with the social problems in the broad conditions and it includes constitutional law, administrative law, criminal law, and criminal procedure law. Rights that deal with public rights are permanently applicable to the state. It depends on the structure of the government. The private right module deals with situation influencing private individuals and corporations. Private rights depend on the substantive and legislative regulation governing relationship in-between individuals.

Private rights can be found in between organizations and employment. For example, the rules of behavior established by an employer. Subdivision of private rights are contract rights, law of torts, Property rights, Labor rights, Commercial rights, Corporations rights, Competition rights. Public rights are circumstances involving public bodies. Normally, public bodies and government officials get their authority to construct decisions and to take embodiment in the form of legislation.

Sending preliminary notice module: The sending of preliminary notice module is defined as sending a notice by a legal entity at the start of their work on a construction project on the real estate. The preliminary notice is required in order to protect right to file a mechanics lien or a bond claim in case the contractor or equivalent party is unpaid. A preliminary notice is a routine letter notifying the property owner of work on the project. Preliminary notices are an opportunity for contractors to introduce themselves to property owners and describe the services or supplies they plan to provide, encouraging transparency in their working relationship with the owner.

The preliminary notice may also be known as NTO (notice to owner), notice of furnishing, prelim, prelien etc. It provides information regarding the company, the work, or materials that the company is providing to the project, and the amount you anticipate being paid for the contributions. Subcontractors who provided professional services, materials, or equipment are required to send preliminary notice to the property owner 60 days from first delivering materials.

Sub-tier parties to send one notice module: The sub-tier parties to send one notice module is defined as sending, by the sub-tier parties like sub-contractors and suppliers, a notice to the main contractors and/or owner regarding their work and contribution and in order to file mechanics lien on construction projects.

The sub-tier parties should send notice for each project in order to get paid timely and move on another project. By sending the preliminary notices helps the sub-tier parties. Further, it brings the attention of the owner. However, Owners have the knowledge of particular companies working on their property. So, they can collect what they owned. Sub-tier parties send notice module make the time management better.

Notice of intent lien (NOI) module: The notice of intent lien is a notice defining consequences of non-payment. Using this, owner, main contractor and/or any other party is warned that mechanics lien or bond claim cannot be filed until/unless payment is made in a given time period. The notice of intent works as a demand letter. The Notice of Intent is the equivalent of a demand letter in a civil case and is generally considered the second step in the procedure for obtaining a lien, just before the formal filing of a lien claim with the court.

The notice of lien becomes ineffective as of the date all charges are paid in full. The notice of intent to lien tool is a kind of pressure release valve for the construction industry, which is popular for payment abuses, delays in work, and challenges regarding working capital. Notice of Intent lien documents typically produce better and faster results with contractors seeing payments an average of 20 days later.

Deadline module: Deadline module is defined as the module that has information about the completion time of every activity involved in a construction project. The owner of each project activity can plan their sub-activities as per the deadline mentioned in this module. Lien may not attach to property and is not enforced unless you have filed a lien within 90 days of deadline module.

The deadline module helps all the parties involved in a project keep track of timeline and anticipate any upcoming delays. Every state has their own specific notice deadlines module and form requirements. Even states that use the same name for preliminary notices vary greatly in their application. Each state has their own statutes that govern the rules and deadlines module for sending notice to protect payment.

Credit offer Appraisal: Credit offer appraisal is the specific credit offer application or proposal to assess the repayment capability of the credit offer applicant. A lender manages a credit appraisal chiefly to construct rules that to increase the probability that the lender gets back its money. Appraisal of credit offers requires a dynamic approach involving, inter alia, a projection of future trends of output, sales, and estimates of costs, returns and flow of funds. There are four broad aspects of credit offer appraisal, namely, technical feasibility, economic feasibility, managerial competence and financial or commercial feasibility.

The credit offer appraisal process checks financial elements, management, market, and other financial details of the credit offer applicant. All the banks and non-banking financial corporations (NBFCs) make use of a credit appraisal policy prior to approving any credit offer application. Each lender may have its own process for performing credit appraisal procedures to assess the credit worthiness of a particular credit offer applicant. The credit appraisal is performed to avoid the possibility of default on credit offers.

Credit offer Equity: Credit offer equity is defined as consolidating high-interest debt at a lower interest rate. With equity funding, money is raised by selling a portion of ownership in the company. Equity credit offer amounts depend on the difference between a current market value and the mortgage due balance. An equity credit offer is the credit offer that is available to you against the equity on a property. A type of consumer debt, home equity credit offer is also known as an equity credit offer, a second mortgage or a home-equity instalment credit offer.

Equity is the difference between the present cost of property and the mortgage owed by the owner. An equity credit offer works similar to a home credit offer, both cases the home serves as collateral. However, for a home credit offer, the eligible credit offer amount is up to 90% of the market value of the house. The fastest way to build equity is to come up with a large down payment, the larger the down payment, the more equity immediately have in home.

Promotional Annual Percentage Rate (APR): Promotional annual percentage rate is the APR of a credit card offered under promotion. Credit card companies charge interest on outstanding balance at the end of billing cycle. Rate of this interest is when annualized is known as APR. A very low APR, when offered as a promotional scheme, is called Promotional APR. The annual percentage rate or the interest rates are normally set high as a short tenure restricts lenders from making adequate profits.

The ledger decides the timing of the promotional rates. A zero percentage of promotional APR may cover to a card's purchase APR or balance transfer APR or both. It mainly dependent on the offer provided by the ledger. For example, if the ledger offers in the card a zero percent promotional APR for both qualifying purchases and balance transfers, the card holder won't have to pay any interest on qualifying purchases or balance transfers during the offer time period.

Contractor credit score: Contractor Credit score is defined as a credit score assigned to a contractor by credit bureaus. This is a measure of contractor's payment practices. Contractor Credit score indicates whether the contractor has a history of paying their bills on time, or if they are slow payers. Further, this score is also used when a contractor applies for a credit offer or line of credit.

The construction credit offers for business or a contractor line of credit depends on a multiple of elements that need to need to be contemplate, including lender requirements, types of credit offers, and contractor credit score. The lenders use the contractor credit score of an individual contractor to identify whether credit offer should be given to a contractor or not and if yes, then what amount can be given as a credit offer to the contractor.

Short term credit offers: A short-term credit offer is a type of Credit offer which is obtained for a short period of time. A business generally takes a short-term credit offer in order to tide over cash crunch in present with a future payment in sight. A short-term credit offer is a type of credit offer that is obtained to support a temporary personal or business capital need. Short term credit offers provide quick cash when your cash flow is lacking, have shorter repayment periods than traditional credit offers.

A prominent example of a short-term credit offer is the products/services purchased with the help of credit cards on EMI. Short term credit offers generally carry a higher rate of interest. Examples of short-term credit offers includes, Overdraft, credit card, Payday credit offers, money market, refund anticipation credit offer, bridge credit offer. Many borrowers prefer short-term credit offers from a direct lender that eliminates any intermediaries such as credit brokers.

Long term credit offers: A long-term credit offer is a type of credit offer which is obtained for a long period of time. This period can be up to 30 years. It is mostly used in a financial industries or organizations with long term goals. For such credit offers the sanction is based on stable and regular income of applicant, future prospect and/or any collateral to be submitted. Long term credit offers are popularly taken from banks and other financial institutions.

Home credit offer, Student/education credit offer, car credit offer etc. are examples of long-term credit offers as the repayment period is more than 3 years. Because of the longer tenure, the interest rates are lower, and many terms & conditions tend to be relaxed as compared to short term or quick credit offers these types of credit offers like education credit offers, car credit offers, home credit offers and certain kind of personal credit offers fall into this category. Benefits of taking a long-term credit offer are lower interest rate, maintain liquidity, flexibility, tax benefits, online application.

Line of credit: A line of credit is a facility provided by a financial institute. Instead of providing the full amount to customer at once, the full amount is stored in an account by the lender. The customer can withdraw any sum of amount, up to and including credit limit, if and when needed. The interest rate is paid only on the amount withdrawn. With a line of credit, a person may borrow as much or as little of the available credit as needed, and only pays interest and fees on that amount.

A credit card holder has a limit of credit available to them. It is not necessary for a card holder to withdraw all their credit once. Thus, a card holder has the provision of creating a line of credit according to their need. Another common line of credit is a home equity line of credit, it secured credit lines backed by the value of the borrower's home, and generally carry low interest rates. Lines of credit are also extended to business owners.

Cash advance: A cash advance is defined as a type of short-term credit offer. Like all short-term credit offers, this also comes with high rate of interest but has advantage of quick approvals or quick funds. In cash advance an amount of money that someone borrows and on which they start to pay interest as soon as they receive it. Credit card cash advances usually come with high fees. A cash advance doesn't directly affect credit score, and credit history won't indicate the borrowed one.

As an example, cash withdrawn from an ATM using a credit card is a form of cash advance. For example, most credit cards let borrow a set amount of cash as an advance that can be pay back with interest, but generally, we can only borrow up to card's cash advance limit and not full credit limit. When take a cash advance, it gets added to credit card balance and accrues interest until its repaid just like purchases and balance transfers do.

Factoring credit offer: The factoring credit offer is a method used by the organizations to raise capital. In a scenario when an organization is in need of capital, but invoices raised for its customers are still being processed, the organization may take a factoring credit offer from a lender using invoices as collateral. In such a scenario, the organization can raise capital up to 90% of invoices value. Financial institute receives payments made by the customers, deducts its fee and then releases rest to the organization.

A factoring credit offer is also known as factoring receivables and is an option for businesses that allow customers up to 3 months for payments. For example, if anyone want to expand business and need money in order to secure a bid for construction, then it can use factoring to get that money. Factoring companies do not take a large percentage of the invoice, a percentage upfront when they purchase the invoice, the rest of the money may come after they have collected, minus the fee they take.

Bankruptcy: Bankruptcy is a legal situation when an entity is unable to repay its outstanding debt. In such a case wherein, a debtor can't repay off its debt, files for bankruptcy in the court of law which may declare the debtor as bankrupt or insolvent. The court then appoints agents who then take the control of the assets of the debtors and apportions it in ratio of the debt owed by creditors on a pro-rata basis. The debtor is then declared as debt free.

For example, when a contractor or a builder borrower some amount from the lender or the bank as its working capital and is supposed to repay the amount to the bank in certain period of time. If the contractor is unable to pay the credit offer in its specific time, then the assets are all sold for the recovery of amount. But if the amount to be recovered by selling all the asserts is not fulfilled then the person is termed as bankrupt.

Collateral: A borrower's assets are referred as collateral when the borrower uses the assets as a security deposit to take out a credit offer. The assets are deposited so that if the borrower defaults on the credit offer, the lender can sell/auction the asset after seizing it and recover a part or full value of the credit offer. Collateral is any property or asset that is given by a borrower to a lender in order to secure a credit offer. Collateral acts as a guarantee that the lender may receive back the amount lent even if the borrower does not repay the credit offer as agreed.

A collateral can be any type of assets such as piece of land or invoices of payments or the business or etc. For example, if a person wants to take out a credit offer from the bank, he may use his house property as collateral. If he fails to repay the credit offer, the collateral may be seized by the bank, based on the two parties' agreement, if the borrower has finished paying back his credit offer, then the collateral is returned to his possession.

Personal guarantee: When a promoter/executive/director of a business makes personal legal promise that if the business fails to repay the credit in part or full, the individual may take the onus to repay the balance of the credit himself/herself; it is termed as personal guarantee. It acts as an extra security for the creditor that safeguards its interest in the credit transaction.

Generally, when the amount sanctioned by the lender is big then the lender prefers to have both collateral as well as personal guarantee for its security. A personal guarantee can be anyone related to the borrower. It is not necessary to add a person in blood relation to the guaranteed list. Although it is necessary to get approval from the guarantee.

Business credit score: The business credit score refers to a number given by the credit rating agencies which implies that whether a company is fit/creditworthy to service a credit offer or not or if they are fit become a business partner/consumer. This score is obtained by analyzing the credit repayment history of the company and their relations with their suppliers and lenders. Multiple parameters such as liens, taxation history, legal proceedings, bankruptcies, longevity, business size etc. are accounted for before this score is given.

When a company or business wants to apply for a credit offer to fulfil its purpose, the Major criteria for getting the credit offer approved may be the business credit score. For credit offer approval, the revenue, profits, assets, and the collateral value of the purpose are required. The major credit scoring firms are Equifax, Experian, and Dun and Bradstreet.

Personal credit score: The personal credit score refers to a number (mostly between 300-850) given by the credit rating agencies (such as CIBIL, Equifax etc.) which implies that whether a person is fit/creditworthy to service a credit offer. Higher is the credit core of a person, better are the chances of the person to obtain credit offer from lender. This scored is obtained by analyzing the credit repayment history of the person and their credit repayment behavior. The lenders use the credit score of individuals to identify whether credit offer should be given to a person or not and if yes, what amount can be given as a credit offer to the borrower.

When an individual applies for a credit offer to fulfil their purposes, the criteria which help them to get credit offer approval are the personal credit scores, assets, and income of an individual. It also helps the borrower to get the credit offer at the least rate of interest. For example, in personal good credit score, the person gets many benefits like cheaper to borrow money, best rates of cars, and homeowner insurance, and good rewards.

Further, “about” as used herein when referring to a measurable value such as an amount, a temporal duration, and the like, is meant to encompass variations of ±20%, ±10%, ±5%, ±1%, and ±0.1% ranges from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. “About” as used herein when referring to a measurable value such as an amount, a temporal duration, and the like, is meant to encompass variations of ±20%, ±10%, ±5%, ±1%, and ±0.1% from the specified value, as such variations are appropriate.

Referring now in detail to the drawings, in which like reference numerals indicate like parts or elements throughout the several views, in various embodiments, presented herein is a system and method for utilizing a mechanic's lien to implement an adjustment. Embodiments of the present disclosure may be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

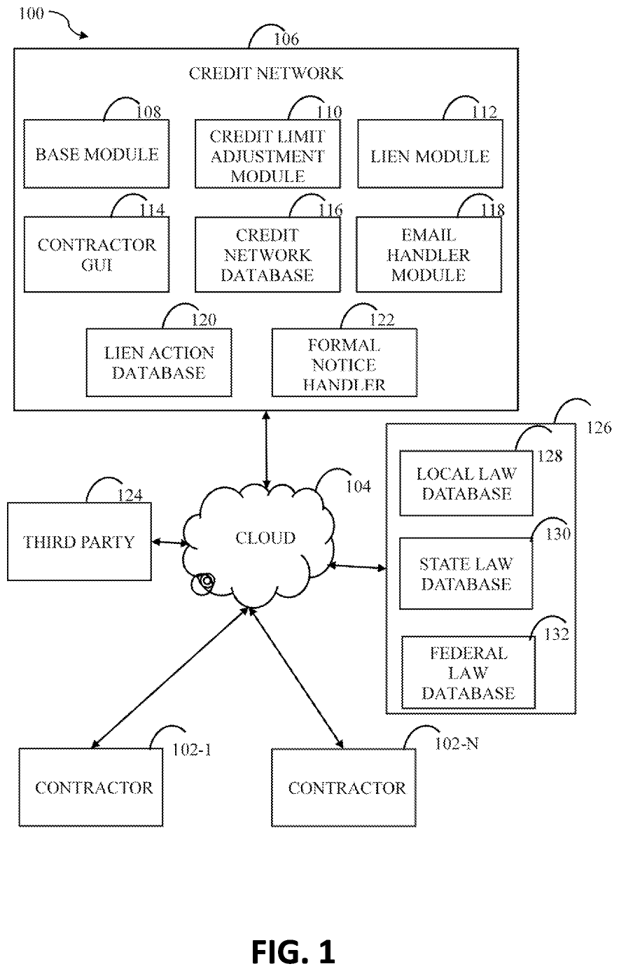

FIG. 1 illustrates an exemplary network environment 100 in which a system for automated project documentation workflows may be implemented. The elements of network environment 100 may be fully integrated for use with any additional platforms, and data output may be used for communicating with other platforms, such as financial institution platforms, user information platforms, cyber security platforms, and payment collection platforms. The network environment 100 may include one or more contractor systems 102 1-N, a cloud 104, and a credit network server 106. One or more contractor systems 102 1-N may be communicatively coupled to the credit network server 106, via the cloud 104. The term contractor or sub-contractor may be used interchangeably used as a user or a borrower or a client.

In one embodiment, the one or more contractor systems 102 1-N may be any system or system device associated with contractors, including but not limited to building construction contractors, road construction contractors, bridge construction contractors, and tunnel construction contractors. The one or more contractor systems 102 1-N may be inclusive of a computing device, desktop, laptop, smartphone, table, computer, smart speaker, smartphones, other wireless digital/cellular devices, or I/O devices to communicate with the credit network server 106 via the cloud 104. The computing device may include an input device and an output device. The input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition which may be utilized as an input for different purposes including authentication and other commands. devices allow for voice recognition and inputs, including, e.g., Microsoft KINECT, SIRI for iPhone by Apple, Google Now or Google Voice Search. Additional mobile devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), or force-based sensing technologies. Some multi-touch devices may allow two or more contact points with the surface, allowing advanced functionality including, e.g., pinch, spread, rotate, scroll, or other gestures.

Further, the cloud 104 may be any communication network implemented for connecting the various devices in the network environment 100. Further, the cloud 104 may be coupled to the one or more contractor systems 102 1-N, via the one or more computing devices, to the credit network server 106. The cloud 104 may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art. The cloud 104 may allow ubiquitous access to shared pools of configurable resources and higher-level services that can be rapidly provisioned with minimal management effort, often over the internet and relies on sharing of resources to achieve coherence and economies of scale, like a public utility, while third-party clouds enable organizations to focus on their core businesses instead of expending resources on computer infrastructure and maintenance. The cloud 104 may also use standard architecture and protocols as understood by those skilled in the art, such as, for example, a packet switched network for transporting information and packets in accordance with a standard transmission control protocol/Internet protocol (“TCP/IP”). Additionally, the network environment 100 may utilize any conventional operating platform or combination of platforms (Windows, Mac OS, Unix, Linux, Android, etc.) and may utilize any conventional networking and communications software as would be understood by those skilled in the art.

Further, the cloud 104 may be used to share information related to the one or more contractor systems 102 1-N. Thus, to protect data of the contractor systems 102 1-N, such as sensitive user financial and personal identification data, government data related to the construction or site plans, other confidential data, and to comply with state and federal laws pertaining to the protection of financial and personal identification data, an encryption standard may be used to protect files from unauthorized interception over the network. Any encryption standard or authentication method as may be understood by those having ordinary skill in the art may be used at any point in the system of the present invention. For example, encryption may be accomplished by encrypting an output file by using a Secure Socket Layer (SSL) with dual key encryption. Additionally, the network environment 100 may limit data manipulation or information access. For example, a system administrator may allow for administration of the system at one or more levels, such as at an individual reviewer, a review team manager, a quality control review manager, or a system manager. Further, the system administrator may also implement access or use restrictions for users at any level. Such restrictions may include, for example, the assignment of user-names and passwords required for use of the system run a check for or to implement an adjustment, backend administrative access, associated mobile device apps, or the selection of one or more data types that the subservient user is allowed to view or manipulate.

In one embodiment, the credit network server 106 may be used to implement the method described herein to automatically generate and file the lien based on the standing of the client. Further, the credit network server 106 may include a base module 108, a credit limit adjustment module 110, a lien module 112, a contractor GUI (graphical user interface) 114, a credit network database 116, an email handler module 118, a lien action database 120, and a formal notice handler 122. The base module 108 may be utilized to determine the risk of the one or more contractor systems 102 1-N and perform an action accordingly. The base module 108 may include one or more sub-modules to generate the lien form. In one embodiment, the base module 108 may adjust the credit limit for the one or more contractor systems 102 1-N, using the credit limit adjustment module 110.

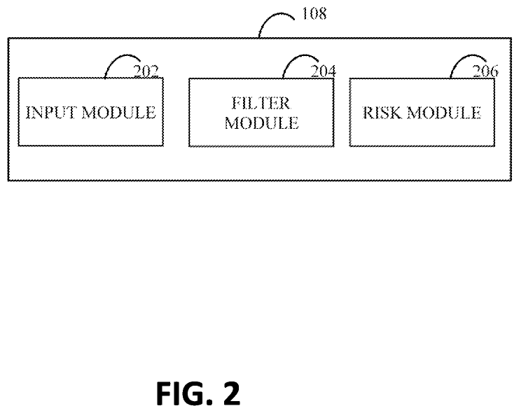

FIG. 2 is a block diagram illustrating an exemplary automated project documentation workflow base module 108. The base module 108 may include an input module 202, a filter module 204, and a risk module 206. The input module 202 may be configured to take input from the credit network database 116. The input may include profile, past and present credit offer information, rate of interest and terms associated with each credit offer, possible adjustments in credit limit for one or more contractor systems 102 1-N. In an exemplary embodiment, the input module 202 in the base module 108 includes input regarding first contractor AB Flooring includes: amount of credit offer $90,000 taken in 2005 and present credit offer amount $46,000 with rate of interest 5% and 7% respectively, for terms 4 years and 10 years and possible adjustment of credit up to $100,000 and $200,000 respectively, second contractor Barrie Drywall includes: amount of credit offer $4,000 taken in 2005 and present credit offer amount $20,000, with rate of interest 3% and 6% respectively, for terms 1 years and 3 years and possible adjustment possible adjustment of credit up to $10,000 and $20,000 respectively, third contractor C&C Plumbing includes: amount of credit offer $5,000 taken in 2003 and present credit offer amount $10,000, with rate of interest 3% and 2% respectively, for terms 1 years and 2 years and possible adjustment of credit up to $10,000 and $20,000 respectively, and fourth contractor Darwin Electric includes: amount of credit offer $9,000 taken in 2006 and present credit offer amount $70,000 with rate of 3% and 9% respectively, for terms 1 years and 5 years and possible adjustment of credit up to $100,000 and $200,000 respectively.

Further, the filter module 204 may be configured and executable to filter current data of one of the one or more contractor systems 102 1-N. In one embodiment, the current data may be filtered for a first contractor new to the system (e.g., the first time). In an exemplary embodiment, the filter module 204 in the base module 108 filters the current data regarding the first contractor AB Flooring. The filtered current data includes amount of credit offer $90,000 taken in 2005 and present credit offer amount $46,000 with a rate of interest 5% and 7% respectively, for terms 4 years and 10 years and possible adjustment of credit up to $100,000 and $200,000 respectively. In another embodiment, the current data may be filtered for the next contractor if the network environment 100 is already functioning to implement automated project documentation workflow(s). In an exemplary embodiment, the current data is filtered for the contractor Barrie Drywall. The filtered current data includes amount of credit offer $4,000 taken in 2005 and present credit offer amount $20,000, with rate of interest 3% and 6% respectively, for terms 1 year and 3 years and possible adjustment possible adjustment of credit up to $10,000 and $20,000 respectively. The risk module 206 may be configured to determine a risk level associated with the one of the one or more contractor systems 102 1-N. The determined risk level may result in different types of credit offers, which may differ by interest rate, payment schedules, and penalties. In one embodiment, the risk level may be calculated at the time the credit offer is made.

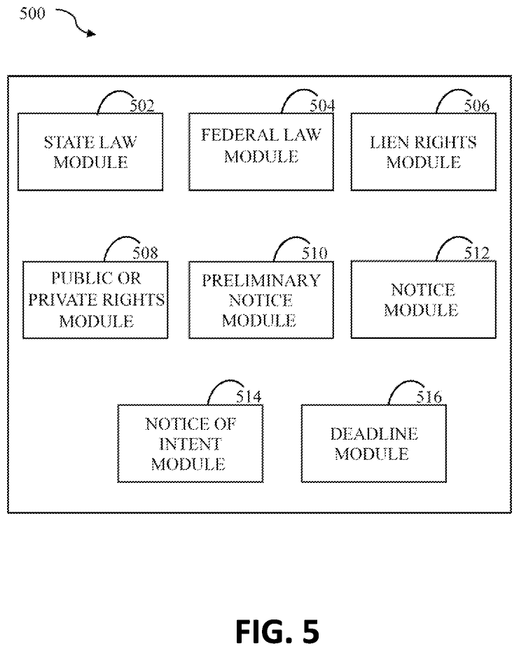

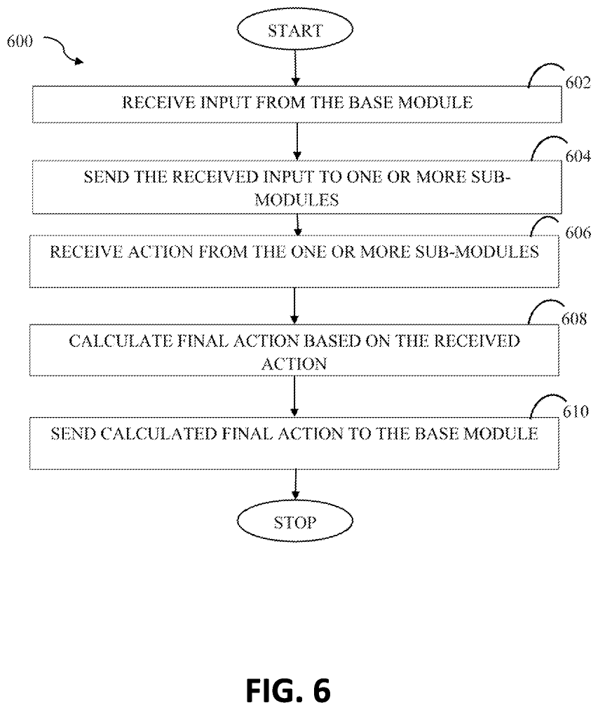

In one embodiment, the lien module 112 may be utilized to calculate the actions to be taken based on the output received from one or more sub-modules. The one or more sub-modules may include state law module, federal law module, lien rights module, public or private rights module, preliminary notice module, notice module, a notice of intent module, and deadline module, which may be explained in conjunction with FIG. 5 and method of operation of the lien module 112 in conjunction with FIG. 6.

The contractor GUI 114 may be a user device graphical user interface (GUI) or guided user interface(s) that may either accept inputs from users or facilitate outputs to the users, or may perform both the actions of input and output. In one case, a user can interact with the interface(s) using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a GUI, a voice interface, or a web-based user-interface. In exemplary embodiments, contractor GUI 114 may present the automated project documentation workflow(s) for approval or further customization prior to implementation, as well as any updates regarding status during implementation.

Further, the credit network database 116 may be used to store data related to the one or more contractor systems 102 1-N. The credit network database 116 may include structured data of all the contractors and sub-contractors in terms of their profiles, their past and present credit offer information, each credit offer with associated terms such as rate of interest and terms, possible adjustments to be offered. In one embodiment, the data may be used by the base module 108 to determine the risk to provide the credit adjustment. Further, the credit network database 116 may be configured to store a systematic collection of data used for electronic storage and manipulation of data. In one embodiment, the credit network database 116 may be of various types such as but not limited to centralized database, cloud database, and network database. The information stored in the credit network database 116 may reflect a robust picture of the contractor's and sub contractor's business and financial soundness. There are no limitations to the number, type or connectivity of the credit network database 116 in the network environment 100.

Further, the email handler module 118 may be used to enable the interaction between the credit network server 106 and the one or more contractor systems 102 1-N. The email handler module 118 may store a set of email scripts to send out email and related data to the one or more contractor systems 102 1-N based upon the event generated. In one embodiment, the email handler module 118 may send an email to the one or more contractor systems 102 1-N, about a lien, a code for the email received from the base module 108, and credit limit adjustment. In an exemplary embodiment, when the lien is detected for a contractor AB Flooring project, the base module 108 sends data about the lien as well as instruction to the email handler module 118 to send the code for the email from the base module 108. On receiving the instruction, the email handler module 118 populates it with the contractor email, data about the lien, the credit limit adjustment of “X” in case the credit risk has increased, and the stock information. The credit network server 106 aggregates all the information and create and send email through the email handler module 118 automatically. Further, the email handler module 118 is also configured to look at the emails received from the one or more contractor systems 102 1-N and classify them using machine learning. The classification of the emails may be performed based on the response of the one or more contractor systems 102 1-N such as contractor agrees or contractor would like to talk to the lender. After performing the classification, the email handler module 118 may send the response to the base module 108.

Further, the lien action database 120 may be used to store data related to the actions received from the one or more sub-modules of the lien module 112. The lien action database 120 may include structured data of all the contractors and sub-contractors in terms of actions to be taken. In one embodiment, the data may include at least but not limited to legal deadline of the lien, actions to be taken to preserve lien rights, public and private rights, preliminary notices, notice of intent. In one embodiment, the data may be used by the lien module 112 to calculate the final action needs to be taken and send to the base module 108 for the contactor GUI 114. In another embodiment, the data may be used by the lien module 112 to calculate the final action needs to be taken and send to the base module 108 for the email handler module 118. In yet another embodiment, the data may be used by the lien module 112 to calculate the final action needs to be taken and send to the base module 108 for the formal notice hander 122. Further, the lien action database 120 may be configured to store a systematic collection of data used for electronic storage and manipulation of data. In one embodiment, the lien action database 120 may be of various types such as but not limited to centralized database, cloud database, and network database. There are no limitations to the number, type or connectivity of the lien action database 120 available in the network environment 100.

Further, the formal notice handler 122 may be used to send mails based upon final action output from the lien module 112. The formal notice handler 122 may store a set of email scripts to send out email and related data to the one or more contractor systems 102 1-N based upon the final action generated from the lien module 112. In one embodiment, the formal notice handler 122 may send a notice to the one or more contractor systems 102 1-N about the coming legal deadline. The formal notice handler 122 may also be utilized to send a lien notice including a payoff option and notices about delinquency.

Further, the cloud 104 may be used to send the lien generated in the credit network server 106 to a third party 124. In one embodiment, the third party 124 may include traditional banks, insurance providers, private and commercial money lenders etc. that can file the lien for the client. In another embodiment, the third party 124 may include any person with the knowledge of filing the lien or organization working on filing the lien. Further, the third party 124 may be present in the same state or in any other state. The third party 124 may be utilized to file the lien form generated by the credit network. Further, the cloud 104 also enable the connection of the credit network server 106 with a database 126. The database 126 may include a local law database 128, a state law database 130, and a federal law database 132. The local law database 128 may include all the information related to the local law of the specific area. In an exemplary embodiment, the local law database 128 includes the local law of Los Angeles. The state law database 130 may include all the information related to the law of the state. In an exemplary embodiment, the state law database 130 includes the state law of California. The federal law database 132 may include all the information related to the law of the country. In an exemplary embodiment, the federal law database 132 includes the law of the U.S.A.

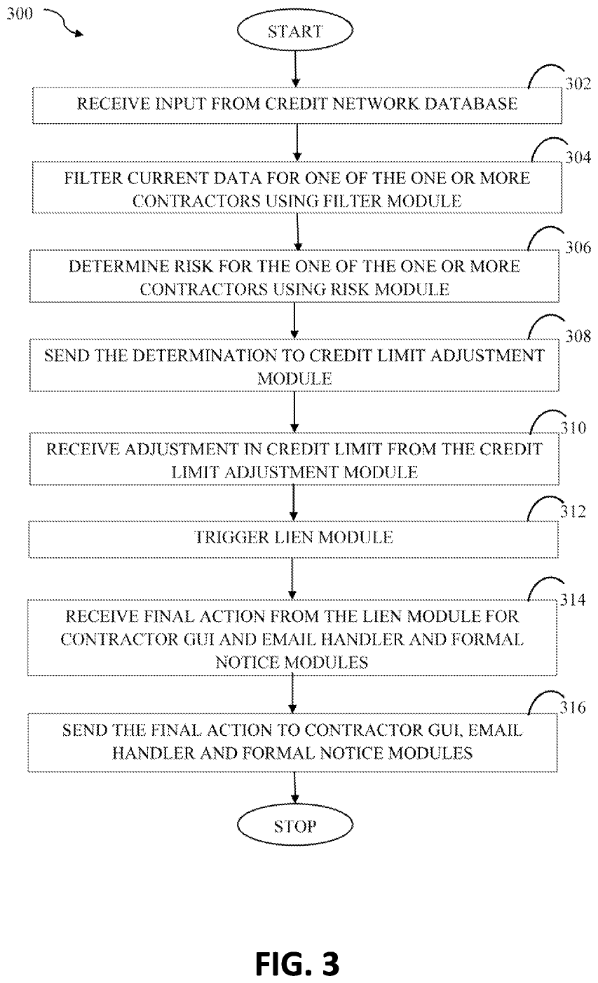

FIG. 3 is a flowchart illustrating an exemplary method 300 for automated project documentation workflow. The method 300 of FIG. 3 is explained in conjunction with the elements disclosed in FIG. 2. In some alternative implementations, the functions noted in the blocks may occur out of the order noted in the drawings. For example, two blocks shown in succession in FIG. 3 may be executed substantially concurrently or the blocks may sometimes be executed in the reverse order, depending upon the functionality involved. In addition, the process descriptions or blocks in flowcharts should be understood as representing decisions made by a hardware structure such as a state machine. The method 300 starts at step 302 and proceeds to step 316.

At first, the base module 108 may receive an input at step 302. The input is received from the credit network database 116. Further, the input module 202 may receive the input for the base module 108. In an exemplary embodiment, the input module 202 in the base module 108 is receiving input regarding the first contractor AB Flooring: amount of credit offer $90,000 taken in 2005 and present credit offer amount $46,000 with rate of 5% and 7% respectively, for terms 4 years and 10 years and possible adjustment of credit up to $100,000 and $200,000 respectively, the second contractor Barrie Drywall: amount of credit offer $4,000 taken in 2005 and present credit offer amount $20,000, with rate of interest 3% and 6% respectively, for terms 1 years and 3 years and possible adjustment possible adjustment of credit up to $10,000 and $20,000 respectively, the third contractor C&C Plumbing: amount of credit offer $5,000 taken in 2003 and present credit offer amount $10,000 with rate of interest 3% and 2% respectively, for terms 1 years and 2 years and possible adjustment of credit up to $10,000 and $20,000 respectively, and the fourth contractor Darwin Electric: amount of credit offer $9,000 taken in 2006 and present credit offer amount $70,000 with rate of interest 3% and 9% respectively, for terms 1 years and 5 years and possible adjustment of credit up to $100,000 and $200,000 respectively.

Successively, the base module 108 may filter current data of one of the one or more contractor systems 102 1-N using the filter module 204 at step 304. In one embodiment, current data for the first contractor is filtered by the filter module 204. In an exemplary embodiment, the filtered data for the first contractor AB Flooring includes: amount of present credit offer amount $46,000 with rate of interest 7%, for terms 10 years and possible adjustment of credit up to $200,000.

Successively, the base module 108 may determine a risk using the risk module 206 at step 306. The risk of the current contractor is determined at the time credit offer is made to the client by the lender. In one embodiment, the risk module 206 may determine the interest rate of the credit offer, schedules for payment of the credit offer, and penalties in case of defaulting or delinquent on payment. In an exemplary embodiment, the risk module 206 determines the credit offer interest rate of 7% for the first contractor AB Flooring for the present credit offer amount $46,000 payment schedules half yearly for 10 years and penalty—a significant drop in credit score.

The base module 108 may send the determination to the credit limit adjustment module 110 at step 308. For example, the base module 108 sends the determination for first contractor AB Flooring including credit offer interest rate of 7% for the present credit offer amount $46,000 payment schedules half yearly for 10 years and penalty—a significant drop in credit score. The determination includes the risk determination made by the risk module 206.

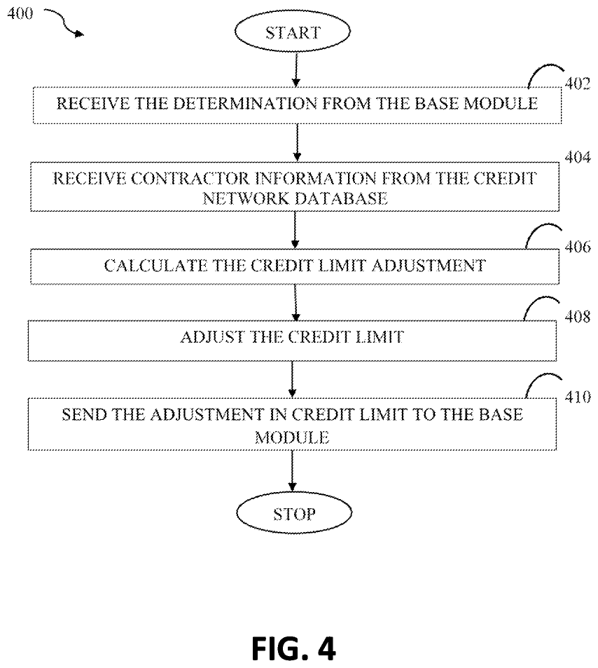

FIG. 4 is a flowchart illustrating an exemplary method 400 for credit limit adjustment, which may result from execution of the credit limit adjustment module 110. The flowchart 400 starts at step 402 and proceeds to step 410.

At first, the credit limit adjustment module 110 may receive the determination from the base module 108 at step 402. The determination may include the interest rate of the credit offer, schedules for payment of the credit offer, and penalties in case of defaulting or delinquent on payment. In an exemplary embodiment, the credit limit adjustment module 110 receives the determination for the first contractor AB Flooring including credit offer interest rate of 7% for the present credit offer amount $46,000 payment schedules half yearly for 10 years and penalty—a significant drop in credit score.

The credit limit adjustment module 110 may receive the contractor information at step 404. The contractor information may be received from the credit network database 116. In an embodiment, the contractor information may include all the past and present credit offers, the rate and the terms associated with each credit offer and possible adjustments to be offered. In an exemplary embodiment, the contractor information includes amount of credit offer $90,000 taken in 2005 and present credit offer amount $46,000 with the rate of interest 5% and 7% respectively, for terms 4 years and 10 years and possible adjustment of credit up to $100,000 and $200,000 respectively.

The credit limit adjustment module 110 may calculate the credit limit adjustment at step 406. For example, the credit limit adjustment module 110 calculates the credit limit adjustment of $200,000 for the present credit offer amount $46,000 for the first contractor AB Flooring. Further, the credit limit adjustment module 110 may adjust the credit limit at step 408. In an exemplary embodiment, the credit limit is adjusted for $154,000.

Successively, the credit limit adjustment module 110 may send the credit limit to the base module 108 at step 410. In an exemplary embodiment, the credit limit of $154,000 for the first contractor AB Flooring is sent to the base module 108. Further, the credit limit adjustment module 110 may send the adjustment in credit limit to the base module 108 at step 410. For example, the credit limit adjustment module 110 sends the credit limit adjustment of $200,000 for the present credit offer amount $46,000 for the first contractor AB Flooring.

Successively, the base module 108 may receive the credit limit at step 310 from the credit limit adjustment module 110. In an exemplary embodiment, the base module 108 receives the credit limit of $150,400 for the first contractor AB Flooring. Successively, the base module 108 may trigger the lien module 112 at step 312.

Further, the base module 108 may receive the final action from the lien module 112 at step 314. For example, the base module 108 receives the final action of sending the notice to first contractor AB Flooring. Further, the base module 108 may send the final action to the contractor GUI, the email handler module 118, and the formal notice handler 122 at step 316. The email handler module 118 may populate a contractor email, data about the lien, the credit limit adjustment of “X” in case the credit risk has increased, and the stock information. The base module 108 aggregates all the information and create and send email through the email handler module 118 automatically. Further, the email handler module 118 is also configured to look at the emails received from the one or more contractor systems 102 1-N and classify them using machine learning. Furthermore, the formal notice handler 122 may send a notice to the one or more contractor systems 102 1-N about the coming legal deadline. The formal notice handler 122 may also be utilized to send a lien notice including a payoff option and notices about delinquency. For example, for contractor AB Flooring, the formal notice handler 122 sends the notice to AB Flooring.

FIG. 5 is a block diagram illustrating an exemplary lien module 500 (which may correspond to lien module 112). As illustrated, lien module may include a state law module 502, a federal law module 504, a lien rights module 506, a public or private rights module 508, the preliminary notice module 510, a notice module 512, a notice of intent module 514, and a deadline module 516.

FIG. 6 is a flowchart illustrating an exemplary method 600 for lien project documentation, which may be performed based on execution of the lien module 112/500. The method 600 starts at step 602 and proceeds to step 610.

At first, the lien module 112 may receive an input from the base module 108 at step 602. The lien module 112 may receive the current data for the one of one or more contractor systems 102 1-N. In one embodiment, the lien module 112 may receive the current data for the first contractor. In an exemplary embodiment, the lien module 112 receives the current data for the first contractor AB Flooring includes: amount of present credit offer amount $46,000 with the rate of interest 7%, for terms 10 years and possible adjustment of credit up to $200,000. In another embodiment, the lien module 112 may receive the current data for the next contractor. In an exemplary embodiment, the lien module 112 receives the current data for the second contractor Barrie Drywall includes: amount of present credit offer amount $20,000 with the rate of interest 6%, for terms 3 years and possible adjustment of credit up to $200,000.

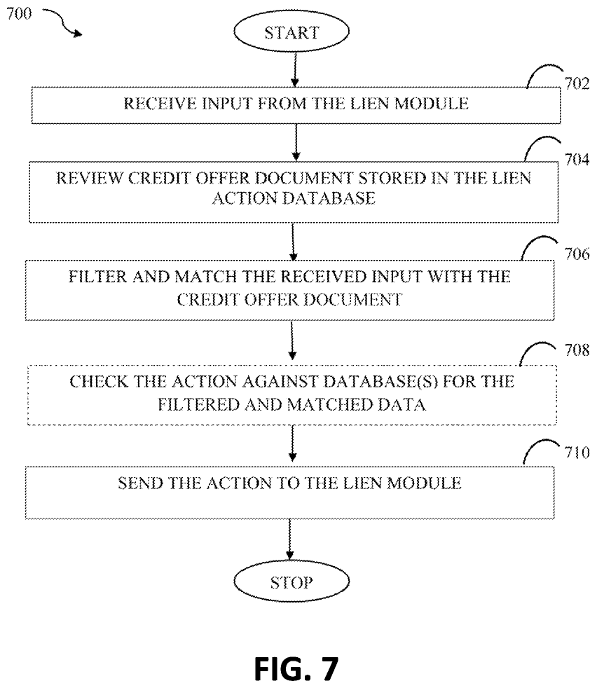

Successively, the lien module 112 may send the received input to one or more sub-modules of the lien module 112 at step 604. The one or more sub-modules may correspond to the state law module 502, the federal law module 504, the lien rights module 506, the public or private rights module 508, the preliminary notice module 510, the notice module 512, the notice of intent module 514, and the deadline module 516. Further, the lien information sent to the one or more sub-modules described in relation to FIG. 7. The one or more sub-modules of the lien module 112 may calculate the actions to be taken and sent them to the lien module 112.

Further, the lien module 112 may receive actions from the one or more sub-modules at step 606. For example, for first contractor AB Flooring, credit offer amount $46,000 rate of interest 7%, term of credit offer 10 years, and payment schedule half yearly, the lien module 112 receives a notice of intent from the notice of intent module 514. The sub-modules of the lien module 500-502 may be utilized to check all the data, review the state law database 130, filter and match for actions, and output actions to the lien module 112 through the lien action database 120, which may be performed in accordance with method 700 of FIG. 7.

Successively, the lien module 112 may calculate a final action based on the received action at step 608. For example, for first contractor AB Flooring, the lien module 112 calculates a final action of sending a notice to AB Flooring, when the lien is generated. The final action may be calculated based on the received actions from the one or more sub-modules. Successively, the lien module 112 may send the calculated actions to the base module 108 at step 610. For example, the lien module 112 sends the action elated to sending the notice to first contractor AB Flooring, to the base module 108.

FIG. 7 is a flowchart illustrating an exemplary method for assessing applicable requirements for automated project documentation workflows in accordance with one or more sub-modules 502-516. The flowchart 700 starts at step 702 and proceeds to step 710.

At first, the state law module 502 may receive an input from the lien module 112 at step 702. The state law module 502 may receive the current data for the one of one or more contractor systems 102 1-N. In one embodiment, the state law module 502 may receive the current data for the first contractor. In an exemplary embodiment, the state law module 502 receives the current data for the first contractor AB Flooring includes: amount of present credit offer amount $46,000 with rate of interest 7%, for terms 10 years and possible adjustment of credit up to $200,000. In another embodiment, the state law module 502 may receive the current data for the next contractor. In an exemplary embodiment, the state law module 502 receives the current data for the second contractor Barrie Drywall includes: amount of present credit offer amount $20,000 with rate of interest 6%, for terms 3 years and possible adjustment of credit up to $200,000.

Successively, the state law module 502 may review the credit offer document at step 704. The credit offer document may be stored in lien action database 120. In an embodiment, the credit offer document may include the details of lender and the client, credit offer amount, rate of interest, term of credit offer, and payment schedule. In an exemplary embodiment, the credit offer document includes the details of Bank of America and the first contractor AB Flooring, credit offer amount $46,000, rate of interest 7%, term of credit offer 10 years, and payment schedule half yearly. Successively, the state law module 502 may filter and match the received input with the credit offer document at step 706.

In step 708, the state law module 502 may check one or more applicable databases 130, such as credit network database 116, lien action database 120, local law database 128, state law database 130, and federal law database 132. For example, state law database 130 may be checked for the filtered and matched data for action needs to be taken in accordance with execution of state law module 502. In an exemplary embodiment, the state law database 130 is a database of California state laws and regulations, which include all the applicable statutes and regulations of the state relating to credit offer agreement. It may therefore be determined that according to the applicable state law, the deadline for sending the lien notice to the first contractor AB Flooring is 3 months after the completion of 10 years of terms of the credit offer.

Similarly, the federal law module 504 may be executed to check all the data, review the federal law database 132, and filter and match for actions. In an exemplary embodiment, the federal law database 132 is a database of the USA, which include all the laws of the application statutes and regulations of the United States relating to credit offer agreement. It may be determined that according to the federal law, the deadline for sending the lien notice to the first contractor AB Flooring is 5 months after the completion of 10 years of terms of the credit offer.

In some implementations, the lien rights module 506 may also be executed to check all the data, review the lien action database 120, and filter and match for actions to preserve the lien rights. In an embodiment, the lien action database 120 may include all the actions required to be taken in case of defaulting or delinquent of the credit offer to preserve the lien rights of the lender. In an exemplary embodiment, the lien action database 120 includes placing one or more liens on property of the client to preserve the lien rights of a bank (e.g., Bank of America).

In addition, the public or private rights module 508 may be executed to check all the data, review the lien action database 120, and filter and match for actions to preserve the public and private rights. The lien action database 120 may be checked for the action to preserve the public or private rights based on the filtered and matched data. In an embodiment, the lien action database 120 may include all the actions required to be taken to preserve the public or private rights module of the lender. In an exemplary embodiment, the lien action database 120 includes actions for preserving the right regarding placing liens on certain property of the client, which may preserve the public or private rights of a certain bank (e.g., Bank of America).

Preliminary notice module 510 may be executed to check preliminary notice data, review the lien action database 120, and filter and match for actions to send one or more preliminary notices. Exemplary actions identified by preliminary notice module 510 may include actions for providing certain required preliminary lien notices (and content thereof) may be identified.

Further, the notice module 512 may be executed to check all notice data, review the lien action database 120, and filters and matches for actions to send one notice to sub-tier parties. Actions regarding any required lien notices may be identified by the notice module 512, for example.

Notice of intent module 514 may be executed to check all notice of intent data, review the lien action database 120, and filter and match for actions to send notice of intent to lien. Exemplary actions identified by notice of intent module 514 may include actions regarding any required or recommend notices of intent to be sent to identified parties, specifically to computing systems of each identified party.

The deadline module 516 may be executed to check all applicable deadline data, review the lien action database 120, and filter and match to check deadline (e.g., deadlines to file the lien from the state law database 130 and the federal law database 132).

In step 710, the determined action(s) may be sent to the lien module 112 at step 710. In an exemplary embodiment, the state law module 502 may determine an action of sending the lien notice within 3 months, which may then be sent to the lien module 112 and stored in the lien action database 120 so that the lien module 112 can access the action from the lien action database 120. The federal law module 504 may determine an action of sending the lien notice within 5 months, which may be sent to the lien module 112 and stored in the lien action database 120 so that the lien module 112 can access the action from the lien action database 120. Likewise, lien rights module 506 may send the action regarding liens on identified property to the lien module 112 for storage in the lien action database 120. Public or private rights module 508 may send the action of lien placement on certain property is sent to the lien module 112 and stored in the lien action database 120. Meanwhile, the preliminary notice module 510 may send any preliminary notice action(s) regarding any liens to the lien module 112, which may also be stored in the lien action database 120. Actions sent by the notice module 512 may include actions to provide certain notice(s) to identified sub-tier parties; such actions may be sent to the lien module 112 and stored in the lien action database 120. Notice of intent module 514 may send actions involving providing certain notices of intent (and content thereof) to certain party systems; the actions may be provided to the lien module 112 and stored in the lien action database 120. Finally, any deadline-related action may be sent by deadline module 516 to the lien module 112 and stored in the lien action database 120.

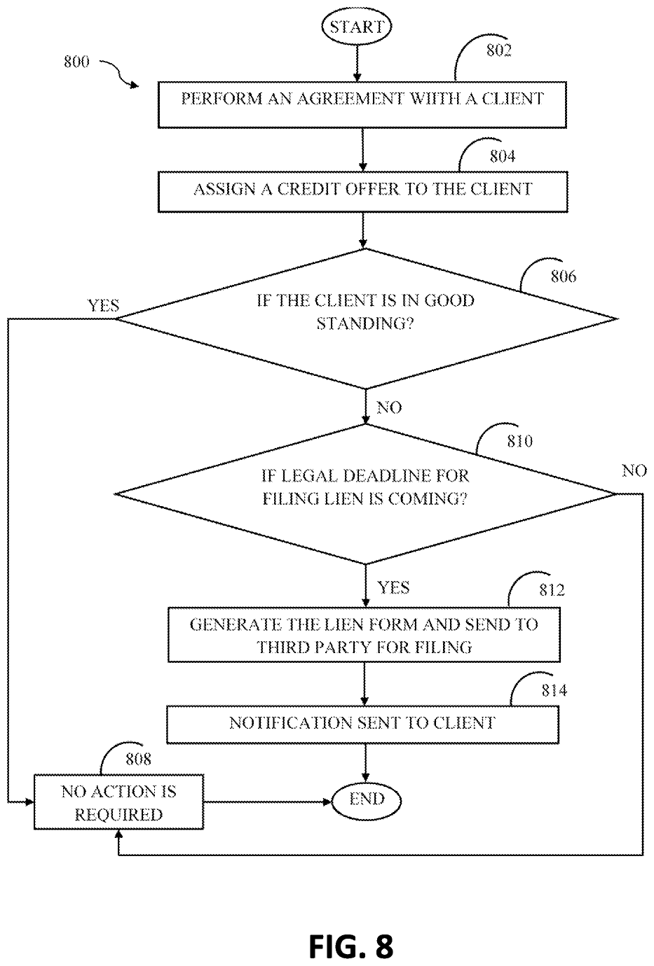

FIG. 8 is a flowchart illustrating an exemplary method 800 for implementing automated project documentation workflows, e.g., for automatically preparing and filing lien documentation with one or more systems based on the standing of a client deadline. The method 800 of FIG. 8 starts at step 802 and proceeds to step 814.

At first, the credit network server 106 may analyze an agreement with the client at step 802. In one exemplary embodiment, data is extracted regarding a credit offer agreement between the lender (e.g., Bank of America) and the client (e.g., AB Flooring), where the client is borrowing a credit offer of $46,000, from the lender for construction project on 51 Queens Avenue, California. Successively, the credit network server 106 may assign a credit offer to the client based on the agreement at step 804. In one exemplary embodiment, the Bank of America provides an agreement of $46,000 to AB Flooring based on the credit offer agreement.

Successively, the credit network server 106 may determine if the client is not in good standing at step 806. For example, a determination is made if AB Flooring has repaid the credit offer to the Bank of America. The determination as to whether the client is not in good standing can be provided for example by data received from the base module 108 of the credit network server 106. The good standing may disclose whether the client is in default or delinquent on payments. In one case, when the credit network server 106 determines that the client is in good standing, then no action is required. In one exemplary embodiment, the client is in good standing only if the account has been approved for funding and the client is in compliance with the credit offer agreement. In another case, when the credit network server 106 determines that the client may not be in good standing, the credit network server 106 may determine if legal deadline for filing the lien is coming may be performed at step 810. In one embodiment, the client is not in good standing only if the client is not in compliance with the credit offer agreement. For example, AB Flooring has not repaid the Bank of America with the agreement of $46,000.

In one case, when the credit network server 106 determines that the legal deadline for filing the lien is not coming, then no action is required at step 808. In another case, when the credit network server 106 determines that the legal deadline for filing the lien is coming, the credit network server 106 may generate a lien form and send to the third party for filing at step 812. For example, for AB Flooring, a lien form indicating that AB Flooring has not repaid the Bank of America with the agreement of $46,000 is sent the third part for filing. Successively, the credit network server 106 may send a notification to the client at step 814. The notification may indicate a generation of lien. In one exemplary embodiment, the credit network server 106 sends a notification to the first contractor AB Flooring that the lien has been generated.

In one embodiment, the automated project documentation workflows may also include standard reporting mechanisms and enhancement of payment performance on credit offers by instituting an automatic system for triggering the lien process, thereby driving payment on the underlying credit offer. Such reporting mechanisms may further include generating a printable receipt of the transaction, or an electronic results report that can be transmitted to any communicatively connected computing device, such as a generated email message or file attachment. Likewise, particular results of the system transaction can trigger an alert signal, such as the generation of an alert email, text or phone call, to alert a user, financial institution or person associated with the user or financial institution. Further embodiments of such mechanisms are described below and according to standards of such systems understood by those skilled in the art.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for automated project document workflows, the method comprising:
receiving information regarding an agreement with a client over a communication network, wherein the received information concerns an offer associated with the agreement;
retrieving data from one or more databases based on the received information indicating a standing of the client;
identifying one or more actions based on the received information and the retrieved data, wherein the actions are identified based on the retrieved data, each action corresponding to required documentation; and
generating one or more lien forms in accordance with the identified actions, wherein the lien forms are automatically populated based on the received information.

2. The method of claim 1, further comprising sending a notification to a device of the client when the lien forms are generated.

3. The method of claim 1, wherein identifying the actions includes identifying one or more recipient systems designated for each of the generated lien forms, and automatically providing the generated lien forms to the designated recipient systems.

4. The method of claim 1, wherein identifying the actions includes identifying one or more deadlines for each of the generated lien forms, and automatically submitting the generated lien forms by the identified deadlines.

5. The method of claim 4, further comprising generating a dashboard display that presents the identified actions and deadlines, wherein the dashboard display further includes a real-time status of each of the identified actions.

6. The method of claim 1, further comprising filtering contents of the agreement to extract information regarding the offer, wherein retrieving the data is specifically based on the extracted information.

7. The method of claim 1, further comprising storing the lien forms in memory in accordance with the identified actions, wherein each of the lien forms is scheduled for transmission at a specified time in accordance with the identified actions.

8. The method of claim 1, further comprising identifying the data to retrieve from the databases based on the standing of the client, wherein the databases include one or more of local database, state database, and federal database.

9. A system for automated project document workflows, the system comprising:
a communication interface that communications over a communication network to:
receive information regarding an agreement with a client, wherein the received information concerns an offer associated with the agreement, and
retrieve data from one or more databases based on the received information indicating a standing of the client; and
a processor that executes instructions stored in memory, wherein the processor executes the instructions to:
identify one or more actions based on the received information and the retrieved data, wherein the actions are identified based on the retrieved data, each action corresponding to required documentation; and
generate one or more lien forms in accordance with the identified actions, wherein the lien forms are automatically populated based on the received information.

10. The system of claim 9, wherein the communication interface further sends a notification to a device of the client when the lien forms are generated.

11. The system of claim 9, wherein the processor identifies the actions by identifying one or more recipient systems designated for each of the generated lien forms, and automatically providing the generated lien forms to the designated recipient systems.

12. The system of claim 9, wherein the processor identifies the actions by identifying one or more deadlines for each of the generated lien forms, and automatically submitting the generated lien forms by the identified deadlines.

13. The system of claim 12, wherein the processor executes further instructions to generate a dashboard display that presents the identified actions and deadlines, wherein the dashboard display further includes a real-time status of each of the identified actions.

14. The system of claim 9, wherein the processor executes further instructions to filter contents of the agreement to extract information regarding the offer, wherein retrieving the data is specifically based on the extracted information.

15. The system of claim 9, further comprising memory that stores the lien forms in accordance with the identified actions, wherein each of the lien forms is scheduled for transmission at a specified time in accordance with the identified actions.

16. The system of claim 9, wherein the processor executes further instructions to identify the data to retrieve from the databases based on the standing of the client, wherein the databases include one or more of local database, state database, and federal database.

17. A non-transitory, computer-readable storage medium, having embodied thereon a program executable by a processor to perform a method for automated project document workflows, the method comprising:
receiving information regarding an agreement with a client over a communication network, wherein the received information concerns an offer associated with the agreement;
retrieving data from one or more databases based on the received information indicating a standing of the client;
identifying one or more actions based on the received information and the retrieved data, wherein the actions are identified based on the retrieved data, each action corresponding to required documentation; and
generating one or more lien forms in accordance with the identified actions, wherein the lien forms are automatically populated based on the received information.
